(19) United States
(12) Patent Application Publication
(10) Pub. No.: US 2026/0342088 A1
(43) Pub. Date: Oct. 29, 2026

(54) POWER CONSUMPTION OPTIMIZATION DEVICE

(71) Applicant: NTT DOCOMO, INC., Tokyo (JP)

(72) Inventors: Ryo TANIMOTO, Tokyo (JP); Masaki NAKAMURA, Tokyo (JP); Kazuhiko TAKENO, Tokyo (JP)

(73) Assignee: NTT DOCOMO, INC., Tokyo (JP)

(21) Appl. No.: 19/146,560

(22) PCT Filed: Mar. 14, 2024
(86) PCT No.: PCT/JP2024/010002

§ 371 Date: Jul. 9, 2025

(30) Foreign Application Priority Data
Mar. 22, 2023 (JP) 2023-045011

(51) Int. Cl. H02J 3/175; H02J 3/00; H02J 7/00; H02J 7/90; H02J 103/30; H02J 103/40; H02J 105/12; H02J 105/37; H02J 105/42

(52) U.S. Cl. CPC H02J 3/175; H02J 3/003; H02J 7/855; H02J 7/933; H02J 7/971; H02J 2103/30; H02J 2103/40; H02J 2105/12; H02J 2105/37; H02J 2105/42

(57) ABSTRACT

An object of the present disclosure is to provide a power consumption optimization system that performs control to optimize electric power charges.

An HEMS controller 100, which is a power consumption optimization device that controls a home power supply system equipped with a storage battery, includes an acquisition unit (basic charge acquisition unit 104a or the like) that acquires pricing structure information of commercial power supply 20, a setting unit 103 that functions as an acquisition unit that acquires setting information for the storage battery 100e, a device 110a, or the like, and a control unit 104 that controls charging and discharging of the storage battery 110e and operations of the device 110a (an EcoCute or an air conditioner) or the like on the basis of the pricing structure information, the setting information, and external factor information (a temperature or resource use history).

### TECHNICAL FIELD

The present disclosure relates to a power consumption optimization device for optimizing power consumption.

### BACKGROUND ART

In recent years, the demand for electricity, which had decreased due to requests for power saving after the Great East Japan Earthquake, is on the rise. In addition, due to instability of fuel procurement caused by various social turmoil, power supply is in an unpredictable state, and there is a demand to curb power consumption. In the industrial sector, since efforts to curb power consumption have been promoted, the demand for electricity has been on a downward trend since the 1990s, and power consumption has remained flat in recent years. On the other hand, power consumption in ordinary households is on the rise, and from the perspective of reducing power consumption nationwide, it can be said that curbing power consumption in ordinary households is a major issue.

Patent Literature 1 includes a description of optimizing operation time periods of each home appliance in consideration of the constraints on multiple home appliances, including continuously operating home appliances and paired operating home appliances. This makes it possible to minimize electric power charges for a certain period of time and curb power consumption.

### REFERENCES CITED

[Patent Literature 1] Japanese Unexamined Patent Publication Application No. 2014-170432

### SUMMARY OF INVENTION

### Problems to be Solved by the Invention

However, this method lacks stability, and depending on conditions, may cause a problem of peaks to occur during time periods when electricity unit prices is lower. Further, it is also conceivable to optimize power consumption in consideration of the electric power charges, but it is required to perform optimal control for each home appliance to be controlled.

Home appliances can be classified into the following three types. That is, they can be classified into appliance type SA (Shiftable Appliance), appliance type CA (Critical Appliance), and appliance type IA (Interruptible Appliance). The appliance type SA indicates appliances that cannot be stopped once operated, but their operation time periods can be changed. The appliance type CA indicates appliances that are essential in daily life and operate at all times during a set time period. The appliance type IA refers to appliances whose operation can be interrupted, but their time periods for use cannot be changed.

For example, they are air conditioners and EcoCute units (water heaters with heat pump function). Air conditioners are often used only during the hot summer time periods (daytime), and it is difficult to change the time periods for use. EcoCute units are often used at night when electricity charges are generally cheaper, and it is not desirable to change the time periods to daytime. In the related art, there is a problem that the optimization is performed for the appliance types SA and CA, storage batteries, and EVs, but the optimization is not performed for the appliance type IA. The power consumption of this type IA may vary greatly depending on external factors, however the above-mentioned prior, optimization that takes external factors into account cannot be performed.

Thus, in order to solve the above-described problems, an object of the present disclosure is to provide a power consumption optimization device that performs control to optimize electric power charges while optimizing power consumption of home appliances by taking external factors into consideration.

### Means for Solving the Problems

A power consumption optimization device of the present disclosure is a power consumption optimization device configured to optimize power consumption of a control target, which includes: an acquisition unit configured to acquire pricing structure information determined on the basis of the maximum instantaneous power consumption of commercial electric power; an acquisition unit configured to acquire setting information for the control target; an external factor information acquisition unit configured to acquire external factor information that affects the power consumption of the control target; and a control unit configured to control the control target on the basis of the external factor information, the pricing structure information, and the setting information.

### Advantageous Effects of Invention

According to the present disclosure, it is possible to optimize electricity rates, such as minimizing the electricity rates by taking external factors into consideration.

### BRIEF DESCRIPTION OF DRAWINGS

FIG. 1 is a diagram showing a system configuration of a home power optimization system of the present disclosure.

FIG. 2 is a block diagram showing a functional configuration of a HEMS controller 100.

FIG. 3 is a block diagram showing a functional configuration of a control unit 104.

FIG. 4 is a diagram showing a specific example of an optimization target time table.

FIG. 5 is a flowchart showing an operation of a home power optimization system 10 of the present disclosure.

FIG. 6 is a flowchart showing an operation of the control unit 104 that performs operation control according to the present disclosure.

FIG. 7 is a diagram showing a functional configuration of a HEMS controller 100a according to a second embodiment.

FIG. 8 is a block diagram showing a functional configuration of the control unit 104 in the HEMS controller 100a of the second embodiment.

FIG. 9 is a flowchart showing an operation of the HEMS controller 100a of the second embodiment.

FIG. 10 is a diagram showing an example of a change in room temperature when optimization processing is executed for an air conditioner.

FIG. 11 is a diagram showing an example of room temperature change when the optimization process is executed on the EcoCute.

FIG. 12 is a diagram showing a comparison of optimization results of the optimization processing according to the present disclosure.

FIG. 13 is a diagram showing comparison results of optimized power consumption for each pricing structure.

FIG. 14 is a graph showing a variable electric power charge unit price

FIG. 15 is a diagram showing an example of a hardware configuration of the HEMS controller 100 according to an embodiment of the present disclosure.

### EMBODIMENTS OF CARRYING OUT THE INVENTION

An embodiment of the present disclosure will be described with reference to the accompanying drawings. The same parts will be denoted by the same reference signs, and repeated description thereof will be omitted, if possible.

A home power optimization system including the HEMS controller 100 according to a first embodiment of the present disclosure will be described.

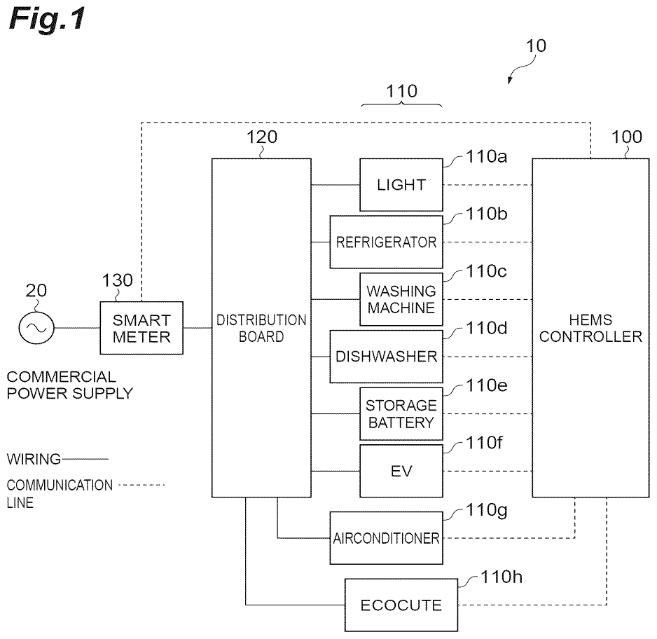

FIG. 1 is a diagram showing a system configuration of the home power optimization system of the present disclosure. This home power optimization system 10 includes a HEMS controller 100, control targets 110, a distribution board 120, and a smart meter 130.

The HEMS controller 100 is a part that performs control of charging and discharging and/or control of an operation of the control targets 110.

The distribution board 120 is a device that branches and distributes electricity from commercial power supply 20 to the control targets 110.

The smart meter 130 is a part that measures electric power supplied from the commercial power supply 20. The HEMS controller 100 is notified of the electric power measured by the smart meter 130. The HEMS controller 100 helps visualize power consumption on the basis of this electric power.

The control targets 110 are a light 110a, a refrigerator 110b, a washing machine 110c, a dishwasher 110d, a storage battery 110e, an EV 110f, an air conditioner 110g, and an EcoCute 110h, but may include other devices. Also, it is not required to include all of these devices. In the present disclosure, the air conditioner 110g and the EcoCute 110h are of appliance type IA, which are appliances whose use can be interrupted, but whose time periods for use are limited to some extent. In addition, the air conditioner 110g is air conditioning equipment and is a device that performs cooling and heating. The EcoCute unit is a device that heats water using heat from the air. Power consumption of these devices varies greatly depending on an external factor (an ambient-temperature or an amount of hot water used).

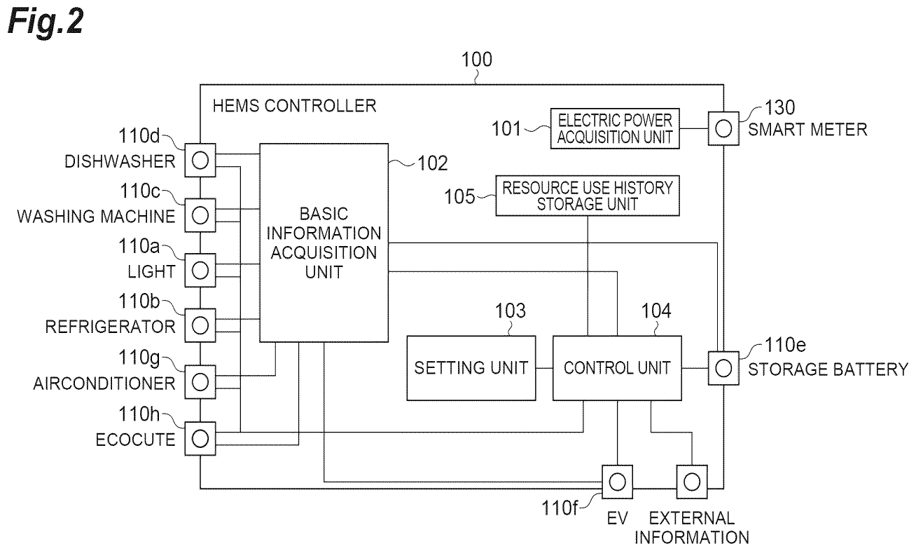

FIG. 2 is a block diagram showing a functional configuration of the HEMS controller 100. As shown in the figure, the HEMS controller 100 is configured to include an electric power acquisition unit 101, a basic information acquisition unit 102, a setting unit 103, a control unit 104, and a resource use history storage unit 105.

The electric power acquisition unit 101 is a part that acquires electric power information measured by the smart meter 130. The HEMS controller 100 has a function of visualizing power consumption, and for that purpose, the electric power acquisition unit 101 may acquire electric power information. Also, this configuration is not essential for the present disclosure.

The basic information acquisition unit 102 functions as a device connection unit for connection to each device, and is a part that acquires basic information from the control targets 110 such as the light 110a. The basic information is information used when optimization calculation of home power consumption is performed, and is information about power consumption of each home appliance serving as the control targets 110 and initial charging amounts, the maximum charging and discharging amounts, and the minimum charging amounts of the storage battery 110e and the EV 110f.

Also, the basic information acquisition unit 102 acquires the maximum power consumption of each control target, use times (use time periods) of each control target, a set temperature of the air conditioner and its allowable room temperature range, a set water temperature of the EcoCute, and past hot water consumption and its allowable room temperature range. Further, It also acquires a time width (slot width) Δt of an optimization target time.

The setting unit 103 is a part that receives setting information and Δt for the control targets 110 (including the storage battery 110e and the EV 110f) set by an operator of the HEMS controller 100. The setting information is a use time of each home appliance serving as the control targets 110, and charging amounts of the storage battery 110e and the EV 110f when the optimization target time has elapsed. At indicates a slot width, which is a control target time unit for operations, and charging and discharging of the control targets 110. These setting information and Δt are set by an operator such as a power company. Depending on a setting width of Δt, fine control can be achieved, but its processing load also increases, and thus it is best to set it to an appropriate width. In addition, a time for DR request and an applicable time period for variable electricity charges can also be set.

The control unit 104 is a part that performs operation control and charging and discharging control of the control targets 110, which include the storage battery 110e, the EV 110f, the air conditioner 110g, and the EcoCute 110h.

The resource use history storage unit 105 is a part that stores information, which is a past resource use amount, used to predict a resource use amount in each time period. In the present disclosure, this past resource use amount indicates, for example, a hot water use amount in each time period in the case of the EcoCute.

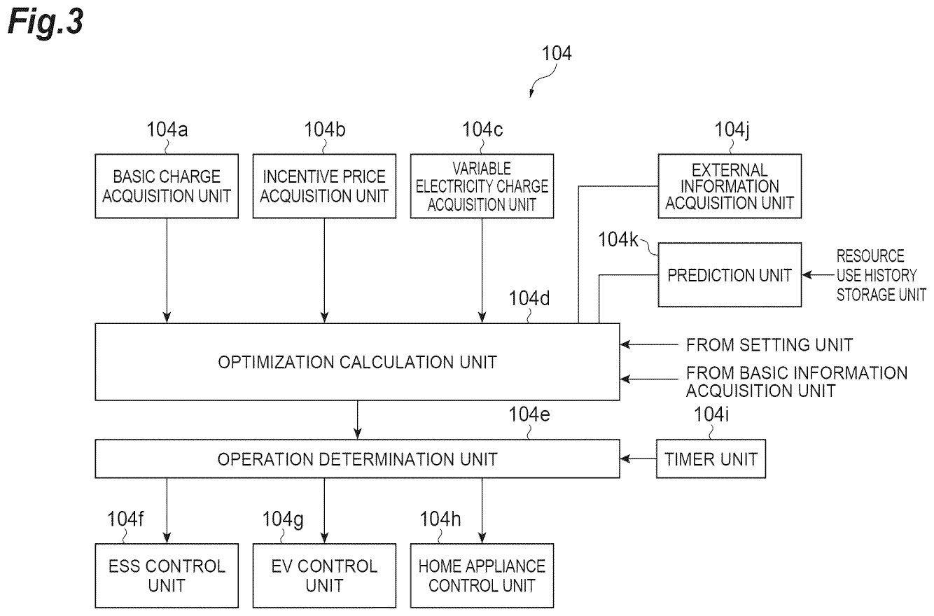

FIG. 3 is a block diagram showing a functional configuration of the control unit 104. As shown in the figure, the control unit 104 is configured to include a basic charge acquisition unit 104a, an incentive price acquisition unit 104b, a variable electricity charge acquisition unit 104c, an optimization calculation unit 104d, an operation determination unit 104e, an ESS control unit 104f, an EV control unit 104g, a home appliance control unit 104h, a timer unit 104i, an external information acquisition unit 104j, and a prediction unit 104k.

The basic charge acquisition unit 104a acquires a basic charge for electric power supplied from the commercial power supply 20. This basic charge is generally determined in accordance with a contracted ampere (contracted capacity) based on the maximum instantaneous power consumption value, and is the minimum charge that occurs regardless of an amount of electric power used.

The incentive price acquisition unit 104b is a part that acquires a kWh value, which is a value paid for 1 kWh of electricity saved during incentive-based demand response (DR). Incentive DR is a mechanism in which incentives are paid as compensation to consumers who save electricity during times of power shortage.

The variable electricity charge acquisition unit 104c is a part that acquires variable electricity charges. This variable electricity charge system is based on price-based DR. This price-based DR indicates a mechanism for adapting a price-variable electricity charge system in which an electric power charge unit price varies depending on a time period. The purpose of this system is to shift home power consumption times and smooth out electric power demand by setting a higher unit price for electricity during a time period when the electric power demand increases and a lower unit price for electricity during a time period when the electric power demand is low.

The optimization calculation unit 104d is a part that performs optimization calculation for operations of each control target 110, and charging and discharging of the storage battery 110e and the EV 110f. This optimization calculation is performed so that peaks of power consumption and electric consumption charges are curbed while electricity charges are minimized. In detail, the optimization calculation unit 104d acquires the basic information and the setting information from the basic information acquisition unit 102 and the setting unit 103, acquires pricing structure information of a basic charge, an incentive price, and a variable charge from the basic charge acquisition unit 104a, the incentive price acquisition unit 104b, and the variable electricity charge acquisition unit 104c, and on the basis of the above information, performs optimization calculation for operations of each control target 110, and charging and discharging of the storage battery 110e and the EV 110f, and the like.

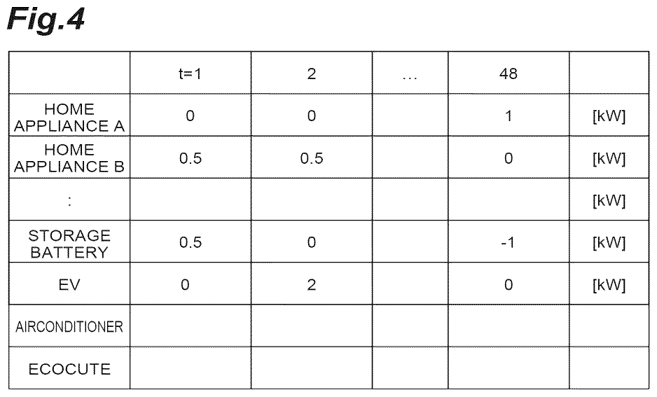

The optimization calculation unit 104d performs the optimization calculation to generate an optimization target time table. FIG. 4 is a diagram showing a specific example of the optimization target time table. As shown in the figure, this table is a table that has the control targets 110 on its vertical axis and time on its horizontal axis. The slot width Δt in the time axis indicates a 30-minute unit. Since there are 24 hours in a day, there are 48 slot columns. The control targets 110 include the home appliances 110a to 110d, the storage battery 110e, the EV 110f, the air conditioner 110g, and the EcoCute 110h.

The numbers in each slot indicate power consumption during Δt. Also, in the numbers for the storage battery 110e and the EV 110f, a positive number indicates charging, 0 indicates standby, and a negative number indicates discharging. The process of generating this optimization target time table will be described later in detail.

The operation determination unit 104e is a part that performs determination of the operations (including charging and discharging of the storage battery 110e and the like) of the control targets 110 using the optimized and generated optimization target time table calculated by the optimization calculation unit 104d. That is, the operation determination unit 104e determines which control target 110 is to be operated during which time period (including during which time period the storage battery 110e and the EV 110f are to be charged and discharged), and outputs instructions to the ESS control unit 104f, or the like, which will be described later.

The ESS control unit 104f performs charging and discharging control of the storage battery 110e on the basis of the determination results of the operation determination unit 104e.

The EV control unit 104g performs charging and discharging control of the EV 110f on the basis of the determination results of the operation determination unit 104e.

The home appliance control unit 104h performs charging and discharging control of the control targets 110 (110a to 110d) on the basis of the determination results of the operation determination unit 104e.

The timer unit 104i is a part that measures time. The operation determination unit 104e performs operation determination on the basis of time measurement of the timer unit 104i.

The external information acquisition unit 104j is a part that acquires external information required for power consumption of the air conditioner, EcoCute, or the like of appliance type IA or the like, which is not dependent on an operation of a user. For example, this external information is an ambient-temperature, but may be other information (for example, humidity, weather, or the like).

The prediction unit 104k is a part that acquires a resource use history from the resource use history storage unit 105 and predicts the resource use amount. For example, the prediction unit 104k predicts the resource use amounts for a time period, day of the week, and season by calculating averages of past resource use fees (for example, hot water usage fees) for each time period, day of the week, or season. The season may be defined in advance, for example, on a monthly basis.

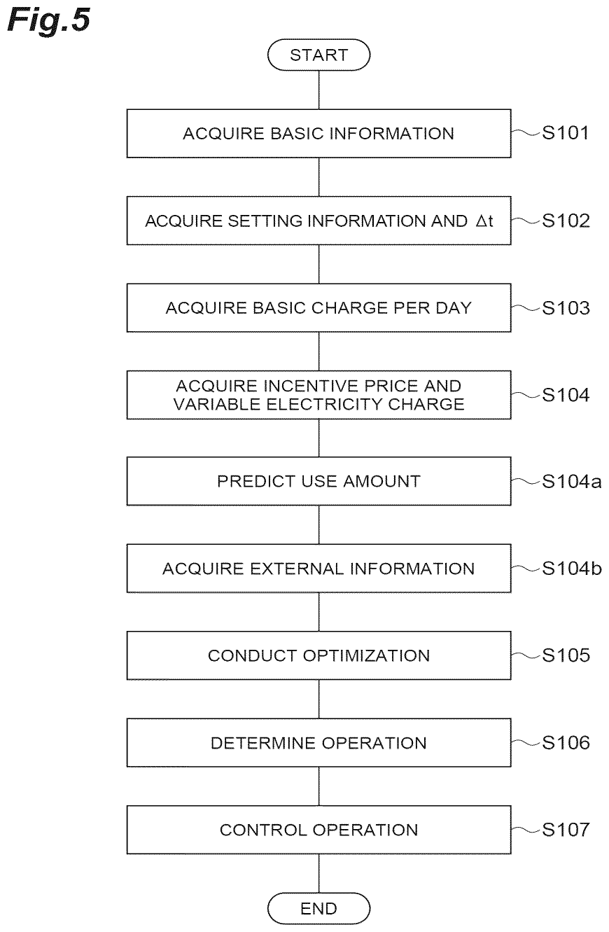

FIG. 5 is a flowchart showing an operation of the home power optimization system 10 of the present disclosure. The basic information acquisition unit 102 acquires the basic information (S101). The setting unit 103 acquires the setting information and Δt (S102).

The basic charge acquisition unit 104a acquires a basic charge per day (S103), and the incentive price acquisition unit 104b acquires an incentive price and a variable electricity charge (S104).

The prediction unit 104k acquires the resource use history from the resource use history storage unit 105 and predicts the resource use amount (S104a). In the present disclosure, the prediction unit 104k predicts a future hot water use amount generated by the EcoCute 110h on the basis of the past hot water use amounts. The resources are not limited to water and hot water, but may include other resources. In addition, set temperatures (minimum and maximum temperatures) of the hot water are also required, but they are values set by the user.

The external information acquisition unit 104j acquires the external information (S104b). In the present disclosure, the external information is an ambient-temperature, but may also include humidity, weather, or the like.

The optimization calculation unit 104d performs the optimization calculation and creates the optimization target time table on the basis of the pricing structure such as the basic charge and the like, the basic information, the setting information, the slot width Δt, and the past resource (hot water) use amount, the external information (temperature), and the set temperatures (minimum and maximum temperatures of the air conditioner and the EcoCute) (S105). Details of this optimization calculation will be described later.

The operation determination unit 104e performs the operation determination for the control targets 110 on the basis of the optimization target table, and issues control instructions to the ESS control unit 104f and the like (S106). Each of the ESS control unit 104f, the EV control unit 104g, and the home appliance control unit 104h performs operation control for each control target 110 (S107).

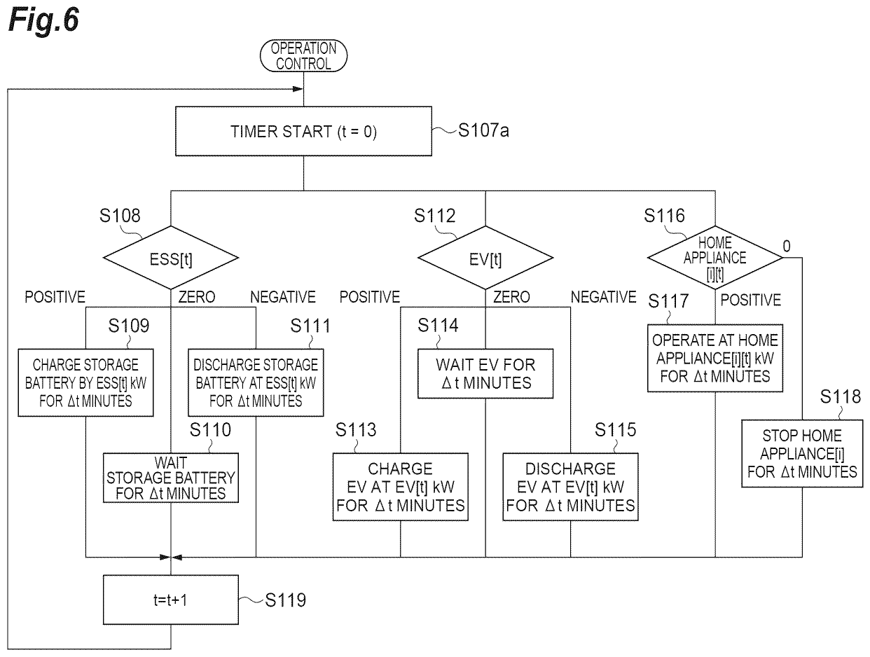

FIG. 6 is a flowchart showing an operation of the control unit 104 that performs the operation control according to the present disclosure. The timer unit 104i starts up (S107a). The ESS control unit 104f, the EV control unit 104g, and the home appliance control unit 104h perform the operation control on the basis of operation states indicated in the optimization target table in a slot t of the timer unit 104i.

The ESS control unit 104f refers to the optimization target time table (S108), refers to operating states of each control target 110 in a specified slot t and performs control in accordance with them.

A numerical value indicating a state that the storage battery 110e should be in is stored in each slot t. A numerical value for the storage battery 110e is called ESS[t], a numerical value for the EV 110f is called EV[t], and a numerical value for another home appliance i (the light 110a to the dishwasher 110d, the air conditioner 110g, and the EcoCute 110h) is called home appliance[i][t]. The character “I” in the home appliance[i][t] indicates a type of home appliance. These numerical values indicate positive: charging, zero: standby, and negative: discharging, and an absolute value thereof is power consumption, which also corresponds to an amount of charging or discharging.

That is, if the numerical value of the storage battery 110e in the slot t is positive, the ESS control unit 104f charges the storage battery 110e at ESS[t] kW during that slot t (S109). In addition, if its numerical value in the slot t is 0, it does nothing during the time indicated by the slot t and waits (S110). If a numerical value of the storage battery of the slot t is negative, the ESS control unit 104f discharges the storage battery 110e at ESS[t] kW during that slot t (S111).

Similarly, the EV control unit 104g refers to the optimization target time table (S112), refers to the operation state in the specified slot t and performs control in accordance with it. If a numerical value of the storage battery 110e in the slot t is positive, the EV control unit 104g charges the EV 110f at EV[t] kW during that slot t (S113). In addition, if its numerical value of the slot t is 0, it does nothing during the slot t and waits (S114). If a numerical value of the EV 110f in the slot t is negative, the EV control unit 104g discharges the EV 110f at EV[t] kW during that slot t (S115).

Similarly, the home appliance control unit 104h refers to the optimization target time table (S116), refers to slot operation states in the specified slot t and performs control in accordance with them. If a numerical value of of slot t of each controlled appliance i is positive, the home appliance control unit 104h operates the home appliance i at home appliance[i][t] kW during that slot t (S117). In addition, if its numerical value of the slot t is 0, it does nothing during the slot t and waits (S118). This home appliance i includes the EcoCute and the air conditioner.

If instructed operations are performed for Δt minutes in the storage battery 110e, the EV 110f, the light 110a, and the like, the control unit 104 increases the value of t by 1 and re-controls the storage battery 110e, the EV 110f, the light 110a, and the like. In this case, the control of the storage battery 110e, the EV 110f, the light 110a, and the like is performed simultaneously, and when both controls are completed, the value of t is increased by 1. This is repeated for the number of slots.

In this way, the operation control and the charging and discharging control are performed on the basis of optimization target time table in which the charging and discharging control of the storage battery 110e and the EV 110f, and the operation control of the control targets 110 (the light 110a to the dishwasher 110d, the air conditioner 110g, and the EcoCute 110h: home appliance i) are optimized, which enables reduction in power consumption, reduction in electricity charges, and reduction in peak power consumption.

Next, an optimization calculation process and generation of the optimization target time table by the optimization calculation unit 104d will be described.

In the present disclosure, among the control targets 110, there are appliance type SA, appliance type CA, and appliance type IA. The appliance type SA (Shiftable Appliance) is a device that can be started at will, but cannot be stopped once it is started, or it is not desirable to stop it. The appliance type CA (Critical Appliance) is a device that must operate for the specified time. The appliance type IA is a device that has a limited operation time, but can be stopped depending on a situation.

Also, the storage battery 110e is generally stationary and can be charged and discharged at any time. In addition, the charging and discharging cannot exceed the maximum charging and discharging power amount. The charging and discharging is preferably performed without falling below the minimum charging and discharging amount. In the final slot, it is desirable to ensure that the charge amount is at least the specified amount.

Basic constraints of the EV110f are the same as those of the storage battery. Since it functions as a car, it cannot be charged or discharged during the time period when it is used as a car. Unlike the storage battery 110e, even in slots other than the final slot, it is required to ensure that the charge amount is at least the specified amount when it is used as a car.

For example, it is desirable for appliance type SA to operate between 5:00 (slot 10) and 8:00 (slot 16). The appliance type CA (Critical Appliance) should be operated 24 hours a day. It is desirable that the storage battery 110e be kept charged at least 50% at all times for disaster purposes, and be kept charged ultimately at least 80%. The EV110f is desired to be used as a car from 8:00 to 12:00 and from 16:00 to 17:00, and thus it is desired to be charged to 100% before the user gets in the car. Each control target 110 has the above constraints.

These features (hereinafter referred to as constraints) are expressed in mathematical formulas and registered as the setting information. For example, the following is exemplified as a mathematical formula for the constraints of the appliance type CA This appliance type CA is one that should be operated during a specified time period (a time to b time). A value of s(t) included in the following constraint is determined to minimize the objective function f(t) described below. Also, s(t) indicates on or off (I/O) of an operation at time t (corresponding to the slot t), and indicates whether or not there is an operation at time t(slot t). sₖ^{CA} indicates an operation of a home appliance k in the appliance type CA. In the following mathematical formula, start and end times of the home appliance k are shown as the constraints. In the following, the operation control is performed for each slot t.

$${s}_{k}^{CA} ( t ) = 1 , t ∈ [ {T}_{k}^{CA , start} , {T}_{k}^{CA , end} ] \qquad [ Equation 1 ]$$

$${s}_{k}^{CA} ( t ) = 0 , t ∉ [ 1 {T}_{k}^{CA , start} , {T}_{k}^{CA , end} ]$$

$${s}_{k}^{CA} ( t ) = \{ \begin{matrix}1 , Critical Appliance k is on operation at timt t . \\ 0 , Critical Appliance k is not on operation at time t\end{matrix}$$

$${T}_{k}^{CA , start} : Operating start time of CA k .$$

$${T}_{k}^{CA , end} : Operating start time of CA k .$$

Also, the following is exemplified as a mathematical formula for the constraints of the appliance type SA. This appliance type SA is one that, once it starts operating, continues to operate for a certain period of time (30 minutes for the washing machine, 90 minutes for the dishwasher, and the like) and cannot be interrupted midway. In the following mathematical formula, d indicates the total operation time of a home appliance k of the appliance type SA. In addition, the second mathematical formula below, Σ|s(t+1)−s(t)|, indicates a non-interruptible constraint in the case of an appliance of type SA. That is, for appliances whose operation can be interrupted, the sum of the differences will not be 2. If the operation is not interrupted, the sum of the differences will be 2.

$$sum ( {s}_{k}^{SA} ( t ) ) = {d}_{k}^{SA} \qquad [ Equation 2 ]$$

$${{\sum }_{t = 1}}^{T} \vert {s}_{k}^{SA} ( t + 1 ) - {s}_{k}^{SA} ( t ) \vert = 2$$

$${s}_{k}^{SA} ( t ) = \{ \begin{matrix}1 , Shiftable Appliance k is on operation at timt t . \\ 0 , Shiftable Appliance k is not on operation at time t\end{matrix}$$

$$T : The number of time slot .$$

Also, the following are examples of mathematical formulas representing the constraints of the storage battery. When the storage battery is charged and discharged, the storage battery is required not to fall below a set minimum charging amount or not to exceed a set maximum charging amount. The charging and discharging of the storage battery do not occur simultaneously. In addition, when the optimization is completed, it is required to exceed a set final charging amount. A mathematical formula that expresses this is as follows. In the following mathematical formula, s^{ch}(t) and s^{dis}(t) indicate discharging and storage in the storage battery at time t and are expressed between 0 and 1. In the first mathematical formula below, if any s^{ch}(t) and s^{dis}(t) is not 0, it indicates the constraint that the mathematical formula does not hold. That is, it indicates that only either charging or discharging can occur. In addition, p^{ch} and p^{dis} indicate the maximum chargeable amount and the maximum dischargeable amount, respectively. EF indicates charging efficiency or discharging efficiency. The following mathematical formula indicates the constraint that a charge capacity of the storage battery should be between the maximum and minimum values. SOCᵢₙᵢₜᵢₐₗ and SOC_{final} respectively indicate an initial value of the charge capacity and a remaining charge capacity when discharged. That is, it indicates that a margin is provided because using a battery to the end when discharged deteriorates the storage battery.

$${s}_{ess}^{ch} ( t ) + {s}_{ess}^{dis} ( t ) = max ( {s}_{ess}^{c h} ( t ) , {s}_{ess}^{dis} ( t ) ) \qquad [ Equation 3 ]$$

$${soc}_{min} \leq soc ( t ) \leq {soc}_{max}$$

$$soc ( t ) = soc ( t − 1 ) + {s}_{ess}^{c h} ( t ) ⋆ {p}_{ess}^{c h} ⋆ {EF}_{c h} + \frac{{s}_{ess}^{d i s} ( t ) ⋆ {p}_{ess}^{d i s}}{E {F}_{dis}}$$

$$soc ( 0 ) = {soc}_{initial}$$

$$soc ( T ) \geq {soc}_{final}$$

$${s}_{ess}^{c h} ( t ) : Continuous value . If it is greater than 0 , ESS is charging at time t . [ 0 - 1 ]$$

$${s}_{ess}^{c h} ( t ) : Continuous value . If it is greater than 0 , ESS is discharging at time t . [ 0 - 1 ]$$

$$soc ( t ) : Charging amount at time t . [ kWh ]$$

$$so {c}_{min} : Minumum charge .$$

$$so {c}_{max} : Maximum charge .$$

$${P}_{ess}^{c h} : Maximum Charging power$$

$${P}_{ess}^{des} : Maximum discharging power$$

$${EF}_{ch} : Charging Efficiency . [ 0 - 1 ]$$

$${EF}_{dis} : Disc harging efficiency . [ 0 - 1 ]$$

Also, for the EV, the mathematical formulas representing the constraints are as follows. The constraints of the EV are almost the same as those of the storage battery, but have the feature that charging and discharging is not possible during the time when the EV is being used as a car. In addition, the EV can be charged and discharged only when it is at home. The mathematical formula for this feature is as follows. Parameters are the same as those of the storage battery described above, but it indicates the constraint that departure and return times of the EV are set and charging and discharging are not allowed during these times.

$${s}_{e v}^{c h} ( t ) + {s}_{e v}^{d i s} ( t ) = max ( {s}_{e v}^{c h} ( t ) , {s}_{e v}^{d i s} ( t ) ) \qquad [ Equation 4 ]$$

$$so {c}_{min} \leq s o c ( t ) \leq s o {c}_{max}$$

$$soc ( t ) = soc ( t − 1 ) + {s}_{e v}^{c h} ( t ) ⋆ {P}_{e v}^{c h} ⋆ {EF}_{e v} + \frac{{s}_{e v}^{d i s} ( t ) ⋆ {P}_{e v}^{d i s}}{E {F}_{d i s}}$$

$$soc ( 0 ) = s o {c}_{i n i t i a l}$$

$$soc ( T ) \geq s o {c}_{final}$$

$${s}_{e v}^{c h} ( t ) = 0 , {s}_{e v}^{d i s} ( t ) = 0 , t ∈ [ {T}_{e v}^{departure} , {T}_{e v}^{a r r i v a l} ]$$

$${T}_{ev}^{departure} : Time to leave home .$$

$${T}_{ev}^{departure} : Time to get home .$$

The following is exemplified as a mathematical formula that expresses features of the air conditioner of the appliance type IA. This air conditioner of the appliance type IA operates so that the room temperature is always between the minimum and maximum room temperatures specified by the user. T_{ambient} indicates the ambient temperature. εₐᵢᵣ is a coefficient that indicates how much it is affected by the ambient-temperature. η_{ac} indicates an efficiency coefficient of the air conditioner. S_{ac}(t) is expressed between 0 and 1 and indicates a rate or degree of operation of the air conditioner. Unlike the other appliances mentioned above, it is not indicated by 0/1, but indicates the degree of operation. Pₘₐₓ indicates the maximum power of the operation of the air conditioner. Kₐᵢᵣ indicates a coefficient of heat conduction.

The second of the following mathematical formulas is a mathematical formula for Tᵣₒₒₘ at time t+1, which indicates how much the room temperature will change at time t+1 from the room and ambient temperatures at time t. This shows the constraint that ensures this changed room temperature is within the range of the first mathematical formula below (between the minimum and maximum temperatures).

$${T}_{min} \leq {T}_{room} ( ∀ t ) \leq {T}_{max} \qquad [ Equation 5 ]$$

$${T}_{room} ( t + 1 ) = {ε}_{air} ⋆ {T}_{room} ( t ) + ( 1 − {ε}_{air} ) ( {T}_{ambient} ( t ) − {η}_{a c} \frac{{s}_{a c} ( t ) ⋆ {P}_{max}}{{K}_{air}} )$$

$${T}_{min} : The desired minimum temperature .$$

$${T}_{max} : The desired maximum temperature .$$

$${T}_{room} : The room temperature at time t .$$

$${T}_{ambient} : The Ambient temperature at time t .$$

$${ε}_{air} : The factor of inertia .$$

$${η}_{a c} : Air Conditioner preformance coefficency .$$

$${s}_{ac} ( t ) : AC operating ratio to maximm power consumption . It ' s continuous value .$$

$${P}_{max} : The maximum power consumption of AC .$$

$${K}_{air} : Thermal conductivity of air .$$

Also, the following is exemplified as a mathematical formula that expresses the features of the EcoCute in the appliance type IA. This EcoCute of the appliance type IA operates so that a water temperature is always between the user-specified minimum and maximum water temperatures. It is assumed that hot water in the EcoCute is always maintained at full capacity, and that ambient-temperature water is replenished in an amount equal to that of the hot water used.

In this mathematical formula, the same parameters as those of the air conditioner are used.

$$\begin{matrix}{T}_{min} \leq T ( ∀ t ) & \leq {T}_{max}\end{matrix} \qquad [ Equation 6 ]$$

$$\begin{matrix}{T}_{water} ( t + 1 ) & = {T}_{ambient} ( t + 1 ) + R ⋆ {s}_{ewh} ( t ) ⋆ {P}_{max}\end{matrix} − ( \frac{M − m ( t + 1 )}{M} ) ( {T}_{ambient} ( t + 1 ) − {T}_{water} ( t − 1 ) ) exp ( − \frac{Δ t}{R ⋆ C} )$$

$$R : Thermal resistance .$$

$${s}_{ewh} ( t ) : EWH operating ratio to maximum power comsumption . It ' s continous value .$$

$${P}_{max} : The maximum power consumption of EWH$$

$$M : The capacity of the water tank .$$

$$m : Hot water usage at time t .$$

$$R : Thermal Resistance of WH [ \frac{° C .}{kW} ]$$

$$C : Thermal Capacitance of WH [ \frac{kWh}{° C .} ]$$

Thus, in the present disclosure, the following function f(t) is prepared, and operation states of each device in each slot are determined to minimize this function, taking into consideration the above mathematically formulated constraints. The above sₖ(t) is pₖ(t) in this objective function.

$$f ( t ) = {\sum }_{t}^{T} c ( t ) {\sum }_{k}^{K} {p}_{k} ( t ) + {\sum }_{t}^{T} α ⋆ \vert {\sum }_{k}^{K} {p}_{k} ( t ) - ap \vert + BC * max ( {\sum }_{k}^{K} {α}_{k} ( t ) ) \qquad [ Equation 7 ]$$

T: Total number of slots
c(t): Electric power charge unit price in slot t
K: Total number of devices (home appliances+storage battery+EV)
pk(t): Power consumption (charging and discharging electric power) of device k in slot t
a: kWh value
ap: Average power consumption amount during optimization target time period
BC: Basic charge
ak(t): Consumption amperage of device k in slot t

This problem can be reduced to a mixed integer programming problem, and once the constraints and the objective function are determined, it can be optimized using a solver. The solver is a function that finds optimal values of variables to obtain a target value in a mathematical formula involving multiple variables. This function is installed in general spreadsheet software. This solver can create an optimal time table for an optimization target by attaching a specific constraint to a certain variable or by changing values of other variables to obtain a maximum or minimum value for a specific variable.

In the present disclosure, operation times, external factors, set temperatures, and power consumption of each control target 110, as well as the minimum charging capacity of the storage battery 110e, time periods during which charging and discharging are not possible for the EV 110f, and the like are defined as constraint conditions. These constraint conditions are defined as constraint information on the basis of the basic information and the setting information. Further, in each control target 110, there are constraints such as not being able to stop for a certain period of time after operation, having to operate for a specified period of time, and the like. For the appliance type IA, a specified operation time is defined.

The above function f(t) is the total value of the electricity charges for each of the variable electric power charge unit price, the kWh value under the incentive rate, and the basic charge. In the present disclosure, the objective is to minimize the function f(t), which indicates the electricity charges, while reducing its peak.

The following mathematical formula of the function f(t) will be explained.

$${\sum }_{t}^{Tc} ε ( t ) {{\sum }_{k}}^{K} {p}_{k} ( t ) \qquad [ Equation 8 ]$$

This mathematical formula represents an electric power charge of a typical metered electricity charge system because it is the sum of the variable electricity charge unit price x power consumption. As a value of the variable electricity charge unit price increases, the influence on the function f (t) becomes greater, and more electricity will be consumed during less expensive time periods. As a result, peak power consumption may occur during time periods at late night.

In the present disclosure, pk (t) includes each of the appliance types SA, CA, and IA

$${\sum }_{t}^{r} α * \vert {\sum }_{k}^{K} {p}_{k} ( t ) \to ap \vert \qquad [ Equation 9 ]$$

This formula is the sum of the kWh value multiplied by differences between power consumption and the average energy consumption for each time period. It indicates an incentives that can be obtained when DR occurs in all time periods. ap is an average power consumption amount during an optimization target time period and is a constant. Also, this value may be a value based on an amount of electric power acquired in the past by the electric power acquisition unit 101. This amount of electric power is calculated by the optimization calculation unit 104d.

The incentive-based DR compares daily power consumption (in the latest week or the like) with power consumption at the time of DR and measures a power saving capacity. For that reason, in order to ensure the power saving capacity at the time of DR, stable power consumption is required. Thus, the above mathematical formula defines stable power consumption-continuing to maintain average power consumption. As the kWh value (a) increases, its influence becomes greater, and power consumption of each slot will be closer to the average power consumption.

$$B C * max ( {\sum }_{k}^{K} {a}_{k} ( t ) ) \qquad [ Equation 10 ]$$

This formula indicates basic charge x maximum instantaneous power consumption (unit: A) during an optimization target time period. The basic charge is contracted based on the number of A (amperage), and its amount varies depending on the maximum instantaneous power consumption. The above mathematical formula is a formula that reflects this. This formula works to reduce the maximum instantaneous power consumption, and thus as the basic charge (BC) increases, it has the function of curbing the peak.

The optimization calculation unit 104d finds pk(t) that minimizes the value of the function f(t) on the basis of the above function f(t) and constraint information, and creates the optimization target time table.

It is assumed that the above HEMS controller 100 can also control the power consumption of each control target 110 (home appliance), such as changing a brightness of the light 110a or reducing the cleaning performance of the washing machine 110c. That is, there are some home appliances, such as the dishwasher 110d and the washing machine 110c, which have flexible operation times. Thus, for the dishwasher 110d and the washing machine 110c, the user does not set the duration of use, but sets their time slots for use. The use time period indicates time periods during which the dishwasher 110d and the washing machine 110c can be operated, and they can be operated at any time within the time periods. The optimization calculation unit 104d takes this information into consideration and performs the optimization to minimize electricity charges.

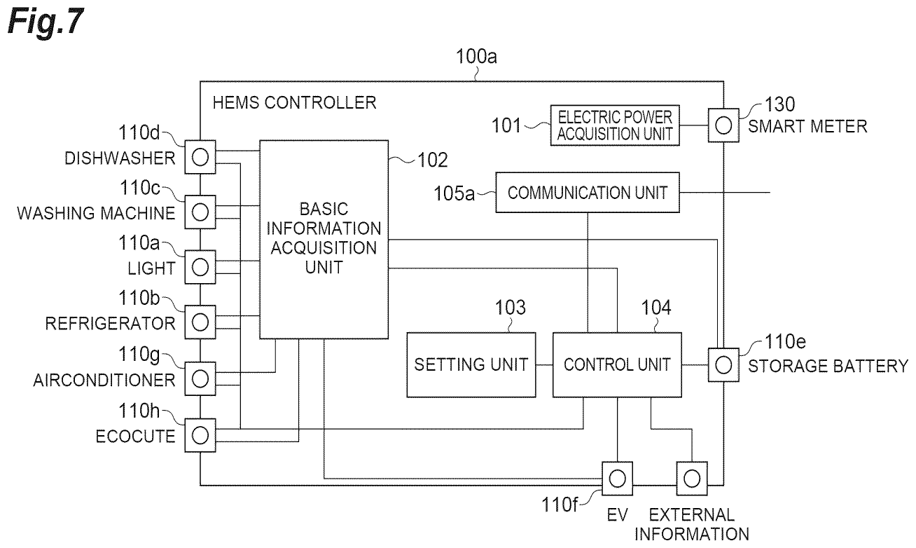

Next, a home power optimization system including a HEMS controller 100a according to a second embodiment of the present disclosure will be described. FIG. 7 is a diagram showing a functional configuration of the HEMS controller 100a according to the second embodiment. In this HEMS controller 100a, a communication unit 105a is provided in place of the resource use history storage unit 105.

This communication unit 105a is a part for acquiring resource use history information stored in an external server or cloud server. In addition, the communication unit 105a transmits commands and necessary information to the external server or cloud server to have the optimization calculation performed, and acquires operation time information of each optimized appliance.

The optimization calculation requires a large amount of calculation, and in order to speed up the process, a method in which the communication unit 105a transmits information required for the optimization to the external server, and after the external server performs the optimization calculation, the HEMS receives only the calculation results is also conceivable. For that reason, the communication unit 105a transmits information required for the optimization calculation to the external server and receives the calculation results. For example, the communication unit 105a transmits the resource use history, the ambient temperature, the user setting values (maximum and minimum temperatures), the pricing structure such as the basic charge, the basic information, the slot width Δt, and the like to the external server.

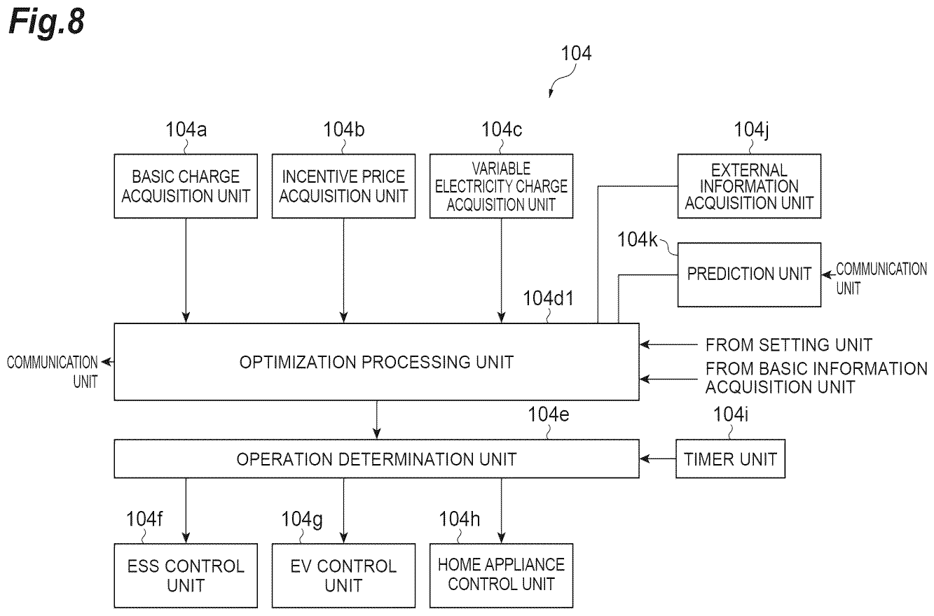

Next, the control unit 104 in the HEMS controller 100a of the second embodiment will be described. FIG. 8 is a diagram showing its functional configuration. The difference from the control unit 104 in the first embodiment is that the prediction unit 104k receives a past resource use amount from the communication unit 105a. In the second embodiment, since the past resource use amount is stored in the external server, the prediction unit 104k acquires the information stored in the external server via the communication unit 105a.

There are two differences in the control according to the second embodiment. The first is that the past resource use amount stored in the external server is acquired via the communication unit 105a before the user's use is predicted. The second is that optimization calculation is not performed in the HEMS controller 100a, but optimization parameters are sent to the external server via the communication unit 105a and the optimization results are received. The optimization parameters here are information required for the optimization calculation, and as mentioned above, include the basic information, the setting information, the resource use history, the ambient-temperature, and the like. Other processes are in accordance with those in the first embodiment.

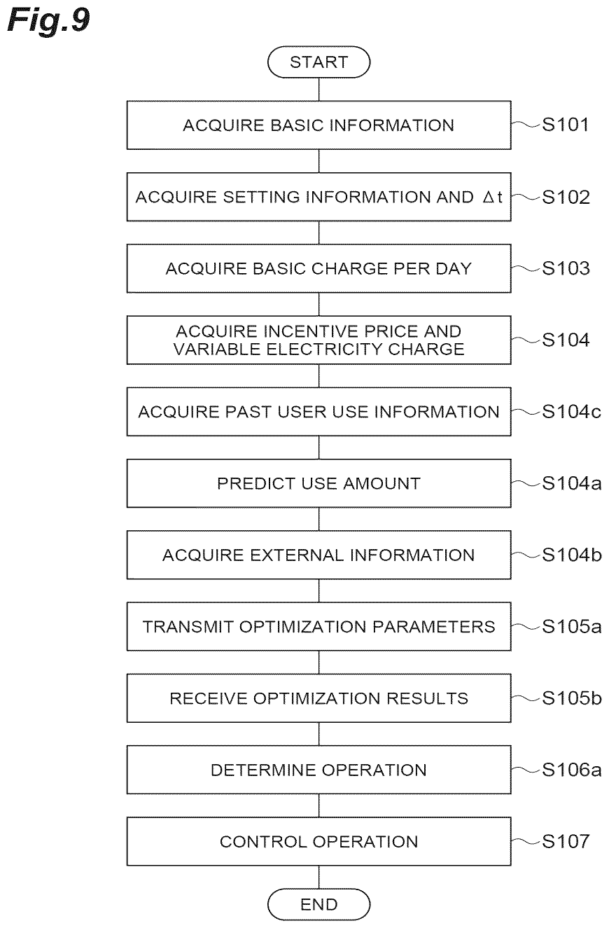

FIG. 9 is a flowchart showing an operation of the HEMS controller 100a of the second embodiment. The basic information acquisition unit 102 acquires the basic information (S101). The setting unit 103 acquires the setting information and Δt (S102). The basic charge acquisition unit 104a acquires the basic charge per day (S103), and the incentive price acquisition unit 104b acquires the incentive price and the variable electricity charge (S104). Up to this point, the process is the same as in the first embodiment.

The communication unit 105a acquires past user's past usage information as a resource usage history (s104c). The user's past usage information (resource usage history) is stored in the external server, and the communication unit 105a acquires the user's past usage information by accessing the external server.

The prediction unit 104k acquires the past user use information (for example, resource: an amount of hot water use) acquired by the communication unit 105a and predicts the use amount (S104a). In the present disclosure, the prediction unit 104k predicts the amount of hot water use to be generated by the EcoCute 110h in the future on the basis of the amount of hot water use in the past. The resources are not limited to water and hot water, and may include other resources. In addition, the set temperature of the hot water is also required, but may be fixed value.

The external information acquisition unit 104j acquires the external information (S104b). In the present disclosure, the external information is the ambient-temperature, but may also include humidity, weather, or the like.

An optimization processing unit 104d1 sends the pricing structure such as the basic charge, the basic information, the setting information, the slot width Δt, the past resource usage, the external information, and the configured temperatures to an optimization calculation server (not shown) to perform an optimization calculation. The optimization processing unit 104d1 receives the optimization results (optimization target time table) (S105b). This optimization calculation is as described above.

The operation determination unit 104e performs the operation determination for the control targets 110 on the basis of the optimization target table (S106). Control instructions are issued to the ESS control unit 104f, and the like. Each of the ESS control unit 104f, the EV control unit 104g, and the home appliance control unit 104h performs the operation control for each control target 110.

Next, a modified example of the HEMS controller 100 according to the present disclosure will be described. In the operation of the control unit 104, necessary information such as the basic information and the setting information is acquired in the order shown in FIGS. 5 and 9 before the optimization calculation, but there is no problem if the necessary information is collected before the optimization calculation, and thus the order of acquiring the necessary information may be changed.

The power consumption and other information of each control target 110 are acquired from the basic information acquisition unit 102, but they may be able to be acquired from the setting unit 103. In addition, the information input in the setting unit 103 may be able to be acquired from the basic information acquisition unit 102.

In the operation of the control unit 104, the charging and discharging states and the charging and discharging amounts of the storage battery 110e and the EV 110f are determined using their signs and absolute values, but any method can be used as long as the charging and discharging states and the charging and discharging amounts can be uniquely determined.

The unit of Δt is minutes, but any unit can be used as long as the time can be divided. Also, in the above example, Δt is 30 minutes, but the present disclosure is of course not limited thereto.

In the present disclosure, the EV 110f has a role as a portable battery, but the device is not limited to the EV110f as long as it has the capability. In FIG. 1, the HEMS controller 100 is independent, but may be incorporated in a distribution board or each control target 110.

For the home appliances serving as the control targets 110 in the present disclosure, any home appliance can be used as long as it satisfies the constraints set forth above. In addition, there is no upper limit to the number of them that may be installed, and the same applies to the EV and the ESS.

In the present disclosure, the power consumption is assumed to be controllable, but the power consumption may be constant simply by turning a switch on and off.

Next, operations and effects of the HEMS controller 100 (power consumption optimization device) of the home power optimization system of the present disclosure will be described. The HEMS controller 100, which is a power consumption optimization device that controls a home power supply system, includes the acquisition unit (basic charge acquisition unit 104a, or the like) that acquires the pricing structure information determined on the basis of the maximum instantaneous power consumption of the commercial power supply 20, and the setting unit 103 that functions as the acquisition unit that acquires the setting information about the storage battery 100e, the light 110a, the air conditioner, the EcoCute, and the like.

The control unit 104 (external information acquisition unit 104j) acquires external factor information (the external information or the resource use history information) that affects the power consumption of the control targets (the air conditioner, the EcoCute, and the like) including the appliance type IA, and the like.

In addition, the control unit 104 includes the control unit 104 that controls the control targets 110 (the charging and discharging of the storage battery 110e and the operations of the light 110a, the air conditioner 110g, the EcoCute 110h, and the like) on the basis of the external factor information, the pricing structure information, and the setting information.

According to this configuration, it is possible to control the charging and discharging of the storage battery 110e or the operations of the light 110a and the like to optimize the electricity charge, for example, to minimize the electricity charge while curbing the maximum instantaneous power consumption.

In the present disclosure, the external factor information is use history information of resources used by the control targets when they operate. If the control target is the EcoCute, which is a device that generates hot water using a heat pump function, the resource is hot water and the use history information is an amount of hot water.

Also, in the present disclosure, the external factor information is environmental information in which the control targets operate. If the control target is the air conditioner that performs air conditioning processing, the environmental information is an ambient-temperature of a place in which the air conditioner is disposed. For example, it is a temperature outside a room in which the air conditioner is installed.

In the present disclosure, the setting information is information indicating the constraints on the operations of the control targets. For example, in a general device (such as the light 110a), it is an operating time period.

Also, this setting information further includes target values for operation of the control targets. For example, by setting the minimum and maximum temperatures as set temperatures (target values) of the air conditioner 110g, power consumption can be optimized by, for example, stopping the operation of the air conditioner 110g as long as the room temperature is within that range.

In the present disclosure, the control unit 104 controls the control targets 110 to minimize the electricity charge using the electricity charge function f(t) that uses the pricing structure information and the setting information.

The control unit 104 uses the electricity charge function f(t) to determine whether or not to operate each control target 110 for each control target 110 and each control target time (slot t). That is, the control unit 104 (optimization calculation unit 104d) generates the optimization target time table, and the operation determination unit 104e controls the operation and the charging and discharging of each control target 110 in accordance with it.

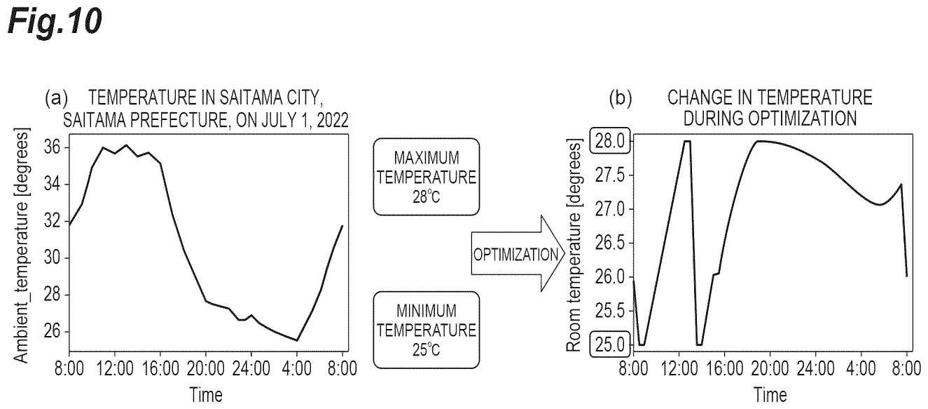

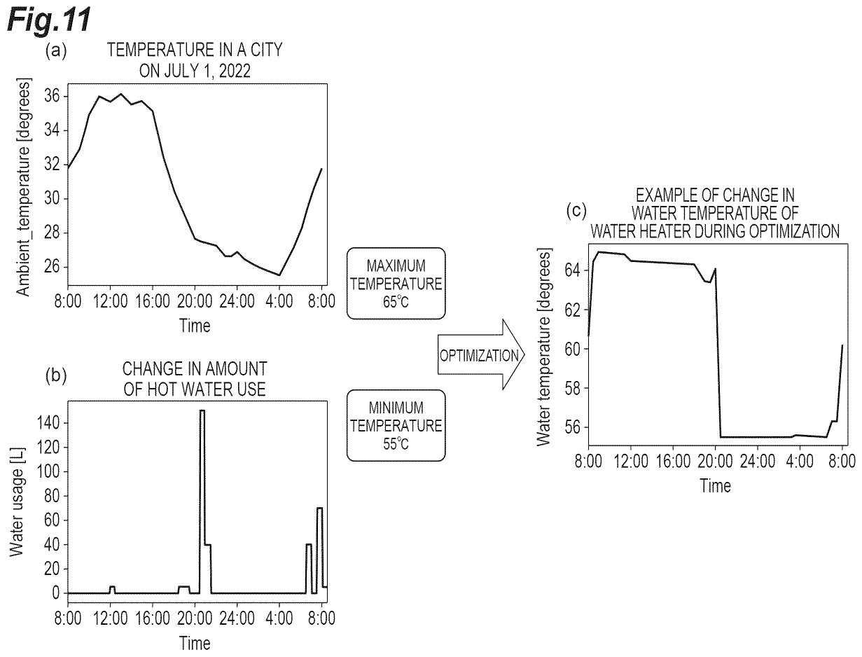

Here, the results of optimization processing for home appliances including the appliance type IA will be explained using FIGS. 10 and 11. FIG. 10 is a diagram showing an example of a change in room temperature when the optimization processing is executed for the air conditioner in a certain home. FIG. 10(a) is a diagram showing the outside air temperature. The power consumption of the air conditioner is determined so that the room temperature satisfies “minimum room temperature (user-specified)≤room temperature≤maximum room temperature (user-specified)” when the ambient-temperature is given. FIG. 10(b) shows an example of a change in room temperature during optimization.

FIG. 11(a) is a diagram showing an example of the ambient-temperature. FIG. 11(b) is a diagram showing the change in the amount of hot water used. As shown in FIG. 11, the power consumption of the EcoCute (water heater) is determined so that the room temperature satisfies “minimum water temperature (user-specified)≤room temperature≤maximum water temperature (user-specified)” when the ambient-temperature and the amount of hot water use are given. Here, it is assumed that the EcoCute is always full and water of the same temperature as the ambient-temperature is replenished as it is used.

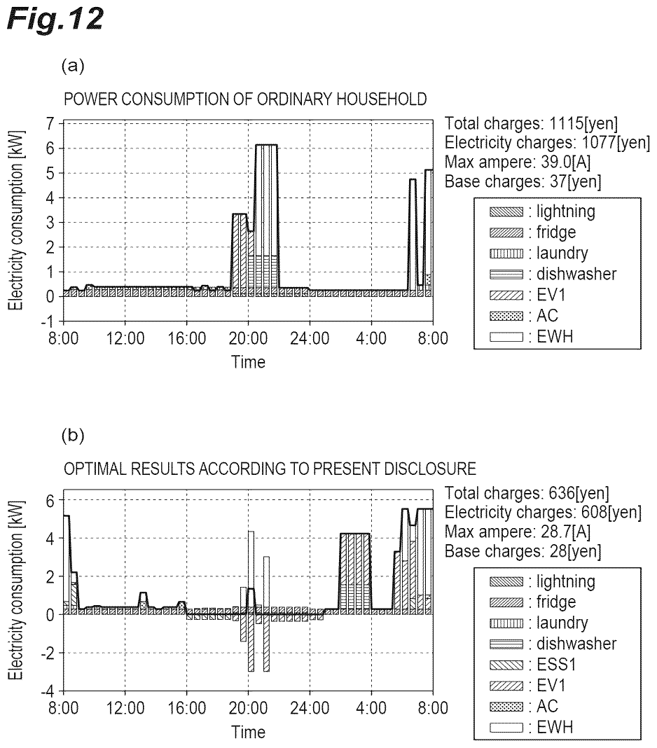

FIG. 12 is a diagram showing a comparison of the optimization results of the optimization processing in a certain home according to the present disclosure. As shown in the figure, FIG. 12(a) is a diagram showing power consumption of an ordinary household to which the optimization processing of the present disclosure is not applied. FIG. 12(b) is a diagram showing the power consumption to which the optimization processing of the present disclosure is applied. As shown in the figure, the peak power consumption is reduced, and the total power cost is also reduced by approximately 41.1%.

In the present disclosure, the pricing structure information includes at least the so-called basic charge, which indicates a minimum use pricing structure system for the electricity charges, and further includes at least one of the incentive price and the variable electricity rage.

These pricing structure have a significant influence on the electricity charges. In particular, the basic charge has an influence on the peak power consumption, and on fluctuations of the electricity charges. In the present disclosure, by taking the basic charge into consideration, it is possible to inhibit the maximum instantaneous power consumption value and realize peak cutting.

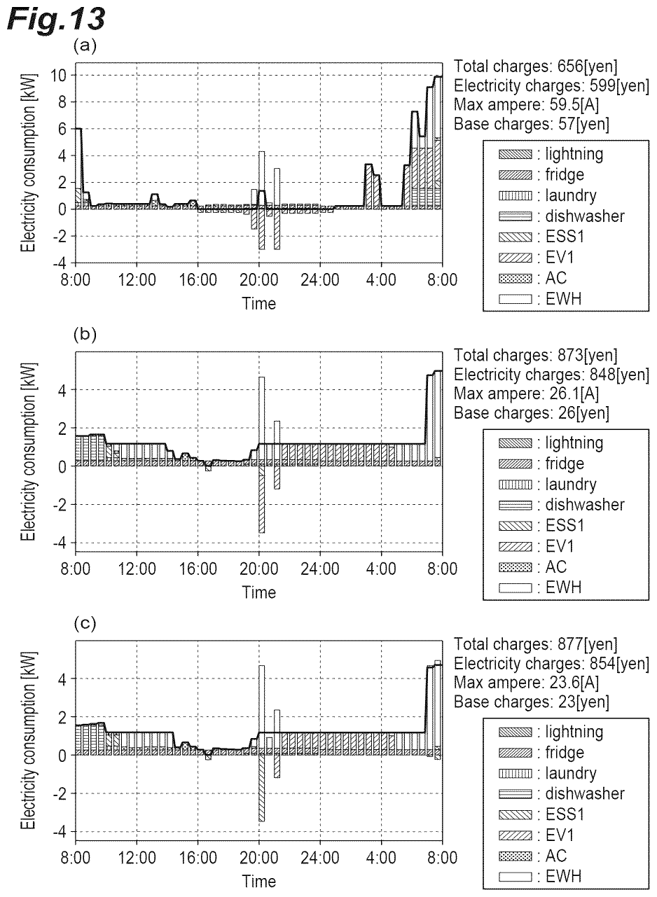

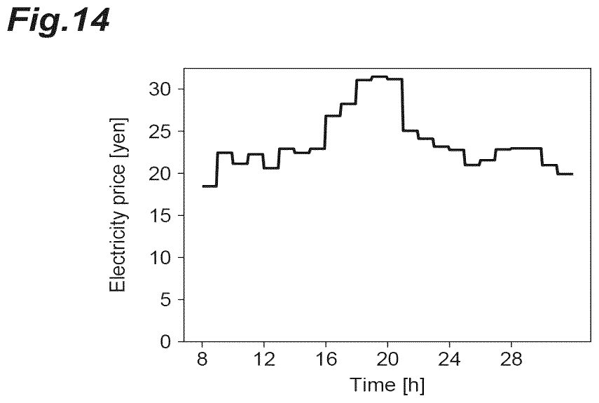

FIG. 13 is a diagram in which the results of the power consumption of each pricing structure are compared. The vertical axis indicates power consumption and the horizontal axis indicates time. For example, “8” indicates 8:00 a.m. “28” indicates 28:00, which is 4:00 a.m. Also, FIG. 14 is a graph showing the variable electricity charge unit price.

FIG. 13(a) is a diagram in which only the variable electric power charge unit price is taken into consideration. As shown in the figure, power consumption (that is, electricity charges) is kept relatively low. FIG. 13(b) is a diagram in which the variable electric power charge unit price and the kWh value (incentive price) are taken into consideration. As shown in the figure, power consumption is kept relatively low. FIG. 13(c) is a diagram showing the variable electricity unit charges, kWh value, and basic charges. As shown in the figure, it can be seen that the peak can be suppressed since the basic charge is taken into consideration.

From the graph of FIG. 13, it can be seen that the charges are cheaper before 8:00 (the beginning of the graph) and around 31:00 (the end of the graph).

In FIGS. 13(a) and 13(b), the reason for the peak at this time (around 8:00) is mainly due to EV charging. The minimum price of the variable electric power charges is from 8:00 to 8:30, but in the simulation according to the present disclosure, the use of the EV as a car is restricted between 8:00 and 19:00, and thus the EV cannot be charged between 8:00 and 8:30, the cheapest time period. For that reason, rapid charging is performed around the 31st hour which is the cheapest among the time periods when charging and discharging are possible (periods when the vehicle is not in use), resulting in a peak. According to the method of the present disclosure, by taking the peak into consideration, it is possible to perform the control so that the overall fluctuation of the power consumption is inhibited.

In addition, by taking the electricity pricing structure into consideration, it is possible to propose optimal results for various cases, such as when the basic charge is more expensive, or when the price per kWh decreases.

When the control target 110 is the storage battery 101e, the control unit 104 controls the charging and discharging of the storage battery 101e.

Also, when the control target 110 is a general device (such as the light 110a), the control unit 104 controls whether or not the general device is operated and its power consumption.

The electricity charge function f(t) is configured of the electric power charge unit price in a time period and the power consumption of a device or charged and discharged electric power of the storage battery.

Also, the electricity charge function f(t) is configured of a value of power savings during the incentive DR and the differences between the power consumption in each time period and the average power consumption.

In addition, the electricity charge function f(t) is based on the maximum instantaneous power consumption at each time.

The power consumption optimization device of the present disclosure has the following configuration.
[1] A power consumption optimization device configured to optimize power consumption for a control target, comprising:
an acquisition unit configured to acquire pricing structure information determined on the basis of the maximum instantaneous power consumption of commercial electric power;
an acquisition unit configured to acquire setting information for the control target;
an external factor information acquisition unit configured to acquire external factor information that affects power consumption of the control target; and
a control unit configured to control the control target on the basis of the external factor information, the pricing structure information, and the setting information.
[2] The power consumption optimization device according to [2], wherein
the external factor information is use history information of a resource used by the control target when the control target operates.
[3] The power consumption optimization device according to claim [2], wherein
in a case in which the control target is a device that generates hot water using a heat pump function,
the resource is water, and
the use history information is an amount of water.
[4] The power consumption optimization device according to [1], wherein
the external factor information is environmental information in which the control target operates.
[5] The power consumption optimization device according to [4], wherein
in a case in which the control target is an air conditioner that performs air conditioning processing,
the environmental information is an ambient-temperature of a place in which the air conditioner is disposed.
[6] The power consumption optimization device according to claim any one of [1] to [5], wherein
the setting information is information indicating constraints on operations of the control target.
[7] The power consumption optimization device according to claim [6], wherein
the setting information further includes a target value at which the control target operates.
[8] The power consumption optimization device according to any one of [1] to [7], wherein
the pricing structure information includes at least a basic charge indicating a minimum use pricing structure for an electricity charge, and further includes at least one of an incentive price and a variable electricity charge.
[9] The power consumption optimization device according to any one of [1] to [8], wherein
the control unit
uses the setting information and an electricity charge function using the pricing structure information to control the control target so that the electricity charge is minimized.
[10] The power consumption optimization device according to [9], wherein
the control unit
uses the electricity charge function to determine whether or not to operate the control target for each control target and control target time.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

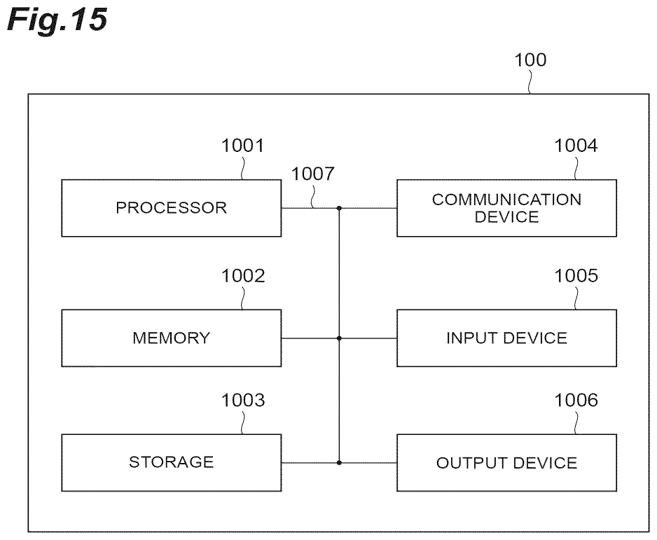

For example, the HEMS controller 100 and the like according to one embodiment of the present disclosure may function as a computer that performs processing of a power consumption optimization method or a conversation information generation method according to the present disclosure. FIG. 15 is a view showing an example of the hardware configuration of the HEMS controller 100 according to one embodiment of the present disclosure. The HEMS controller 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the HEMS controller 100 may be configured to include one or a plurality of the devices shown in the drawings or may be configured without including some of those devices.

The functions of the HEMS controller 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the above-described control unit 104 may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the control unit 104 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (Erasable Programmable ROM), EEPROM (Electrically Erasable Programmable ROM), RAM (Random Access Memory) and the like, for example. The memory 1002 may be also called a register, a cache, a main memory (main storage device) or the like. The memory 1002 can store a program (program code), a software module and the like that can be executed for implementing a power consumption optimization method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described electric power acquisition unit 101, basic information acquisition unit 102 and the like may be implemented by the communication device 1004.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel). The input device 1005 may function as the setting unit 103.

In addition, the devices such as the processor 1001 and the memory 1002 are connected by the bus 1007 for communicating information. The bus 1007 may be a single bus or may be composed of different buses between different devices.

Further, the HEMS controller 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning.

Further, information, parameters and the like described in the present disclosure may be represented by an absolute value, a relative value to a specified value, or corresponding different information. For example, radio resources may be indicated by an index.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

Reference Signs List

10 Home power optimization system,
100 HEMS controller,
110 Control target,
120 Distribution board,
130 Smart meter,
110a Light,
110b Refrigerator,
110c Washing machine,
110d Dishwasher,
110e Storage battery,
110f EV,
101 Electric power acquisition unit,
102 Basic information acquisition unit,
103 Setting unit,
104 Control unit,
104a Basic charge acquisition unit,
104b Incentive price acquisition unit,
104c Variable electricity charge acquisition unit,
104d Optimization calculation unit,
104e Operation determination unit,
104f ESS control unit,
104g EV control unit,
104h Home appliance control unit,
104i Timer unit

1. A power consumption optimization device configured to optimize power consumption for a control target, comprising:
an acquisition unit configured to acquire pricing structure information determined on the basis of the maximum instantaneous power consumption of commercial electric power;
an acquisition unit configured to acquire setting information for the control target;
an external factor information acquisition unit configured to acquire external factor information that affects power consumption of the control target; and
a control unit configured to control the control target on the basis of the external factor information, the pricing structure information, and the setting information.

2. The power consumption optimization device according to claim 1, wherein
the external factor information is use history information of a resource used by the control target when the control target operates.

3. The power consumption optimization device according to claim 2, wherein
in a case in which the control target is a device that generates hot water using a heat pump function,
the resource is hot water, and
the use history information is an amount of hot water.

4. The power consumption optimization device according to claim 1, wherein
the external factor information is environmental information in which the control target operates.

5. The power consumption optimization device according to claim 4, wherein
in a case in which the control target is an air conditioner that performs air conditioning processing,
the environmental information is an ambient-temperature of a place in which the air conditioner is disposed.

6. The power consumption optimization device according to claim 1, wherein
the setting information is information indicating constraints on operations of the control target.

7. The power consumption optimization device according to claim 6, wherein
the setting information further includes a target value at which the control target operates.

8. The power consumption optimization device according to claim 1, wherein
the pricing structure information includes at least a basic charge indicating a minimum use pricing structure for an electricity charge, and further includes at least one of an incentive price and a variable electricity charge.

9. The power consumption optimization device according to claim 1, wherein
the control unit
uses the setting information and an electricity charge function using the pricing structure information to control the control target so that the electricity charge is minimized.

10. The power consumption optimization device according to claim 9, wherein
the control unit
uses the electricity charge function to determine whether or not to operate the control target for each control target and control target time.
